(19) United States
(12) Patent Application Publication
(10) Pub. No.: US 2025/0355132 A1
(43) Pub. Date: Nov. 20, 2025

(54) METHOD AND SYSTEM FOR ANALYZING A RESERVOIR GEOLOGICAL FORMATION BY SKELETON COMPUTATION ON A LARGE RESERVOIR GRID

(71) Applicant: TotalEnergies OneTech, Courbevoie (FR)

(72) Inventors: Pierre Thore, Pau (FR); Antoine Lucas, Pau (FR)

(21) Appl. No.: 18/873,561

(22) PCT Filed: Jun. 10, 2022
(86) PCT No.: PCT/IB2022/000313

§ 371 Date: Dec. 10, 2024

(51) Int. Cl. G01V 20/00

(52) U.S. Cl. CPC G01V 20/00

(57) ABSTRACT

A computer implemented method for analyzing a reservoir geological formation uses a reservoir grid corresponding to a 3D grid of cells wherein each cell represents a respective portion of the reservoir geological formation. The method includes determining a skeleton of the reservoir grid and analyzing the reservoir geological formation based on the skeleton. The skeleton is determined by front-propagating from an initial seed cell to determine front propagation paths in the reservoir grid, by determining flux values for cells of the reservoir grid by back-propagating along the front propagation paths, and by filtering the flux values. The method further includes splitting the reservoir grid into N_{B}≥3 blocks, and back-propagating along the front propagation paths, up to any processed block, only from downstream blocks which are within a block distance D_{B}≤N_{B}−2 from the processed block.

### BACKGROUND

### Technical Field

This disclosure relates to the field of reservoir geological formations modeling and exploitation and relates more particularly to a method and system for analyzing a reservoir geological formation by skeleton computation on a reservoir grid representing said reservoir geological formation.

### Description of the Related Art

In the field of hydrocarbon (oil, natural gas, shale gas, etc.) recovery from an underground reservoir geological formation, it is known to establish a simulation model of said reservoir geological formation. Such a simulation model relies on a reservoir grid to simulate the flow of fluids inside the reservoir geological formation in order to be able to, e.g., optimize the recovery of hydrocarbons from the reservoir geological formation. Such a simulation model may also be used, e.g., in the field of carbon capture utilization and storage (CCUS) in the reservoir geological formation.

For instance, such a simulation model may be used to predict the amount of oil/CO₂ that may be recovered/stored as a function of the amount of water injected into the reservoir geological formation.

The reservoir grid represents the 3D volume of the underground reservoir geological formation as a 3D grid of cells, each cell corresponding to a volume of the 3D grid which may be substantially cubic or have a more complex shape. Each cell of the reservoir grid is mapped to a corresponding portion of the reservoir geological formation. Each cell of the reservoir grid is associated to values of geological properties of the corresponding portion of the reservoir geological formation. The geological properties may be, e.g., the facies (geological index), the porosity, the permeability, etc.

In the present disclosure, we designate also by reservoir grid any 3D or 4D seismic image representing the reservoir geological formation. In such a case, the cells correspond to voxels representing respective portions of the reservoir geological formation, and each cell is associated to values of geophysical properties of the corresponding portion of the reservoir geological formation. The geophysical properties may be, e.g., the seismic wave velocity change (4D), the acoustic impedance, the rock density, etc.

In order to be able to improve the analysis of the reservoir geological formation, it has been proposed in the PCT application WO 2020/254851 A1 to compute a skeleton of the reservoir grid, which skeleton describes the topology underlying the values of the geological and/or geophysical properties of the reservoir grid. This solution has proven to be very effective.

However, the solution proposed in WO 2020/254851 A1 (or more generally, most skeletonization algorithms) requires storing the whole reservoir grid (i.e., all cells) in a random-access memory (RAM), and possibly in the memory stack of the computing system. While this may not be an issue in most cases (e.g., for reservoir grids comprising around 10⁶ or 10⁷ cells), the solution proposed in WO 2020/254851 A1 may be difficult to apply for very large reservoir grids due to the memory constraints. For instance, it might be required to rely on a large reservoir grid when, e.g., the reservoir geological formation covers a very large area, or when the reservoir grid corresponds to micro computed tomography, CT, image (a.k.a. digital rock physics) which may have a resolution lower than 10 microns.

Accordingly, there is a need for a solution enabling computing skeletons for large reservoir grids in terms of memory footprint required.

### BRIEF SUMMARY

The present disclosure aims at improving the situation. In particular, the present disclosure aims at overcoming at least some of the limitations of the prior art discussed above, by proposing a solution for reducing the memory constraints for computing skeletons for reservoir grids.

Also, in some embodiments, the present disclosure aims at proposing a solution enabling to compute a skeleton in a more computationally effective manner, thereby reducing the processing time and enabling to obtain relevant skeletons more quickly than the prior art solutions, or better skeletons than the prior art solutions when considering a same processing time.

According to a first aspect, the present disclosure relates to a computer implemented method for analyzing a reservoir geological formation by using a reservoir grid, said reservoir grid corresponding to a 3D grid of cells wherein each cell represents a respective portion of the reservoir geological formation, wherein said method comprises determining a skeleton of the reservoir grid and analyzing the reservoir geological formation based on the skeleton, wherein the skeleton is determined by front-propagating from at least one initial seed cell to determine front propagation paths in the reservoir grid, by determining flux values for cells of the reservoir grid by back-propagating along the front propagation paths, and by filtering the flux values. The analyzing method comprises splitting the reservoir grid into N_{B} blocks, with N_{B}≥3, and:
front-propagating from an initial block comprising the at least one initial seed cell to identify blocks adjacent to the initial block and which are downstream to said initial block according to the front propagation paths, and determining at least one downstream seed cell in each downstream block that is adjacent to said initial block,
iteratively front-propagating in each downstream block which comprises at least one downstream seed cell determined based on the front-propagating paths of an upstream block.

Also, the analyzing method comprises processing each block which comprises an initial seed cell or a downstream seed cell by:
back-propagating along the front propagation paths, up to the processed block, only from downstream blocks which are within a predetermined block distance D_{B} from the processed block, wherein 1≤D_{B}≤N_{B}−2,
filtering the flux values of the processed block obtained by back-propagating only from within the block distance D_{B}, thereby producing a block-skeleton for the processed block,
wherein the skeleton for the reservoir grid is obtained by combining the block skeletons obtained for the processed blocks.

Hence, as in WO 2020/254851 A1, the analyzing method computes a skeleton by performing a front-propagation in order to determine front propagation paths in the reservoir grid. A back-propagation is performed on the front propagation paths to obtain flux values for all or part of the cells of the reservoir grid. Typically, in a front propagation path, a visited cell may have a parent cell (or father) which corresponds to a cell which is upstream the visited cell according to the front propagation path. Hence the front-propagation implements a front-propagation algorithm and stores for each visited cell an indication of which cell is its immediate parent cell. The back-propagation then traces back the visited cells and flux values may be computed, for instance, by counting for each cell the total number of downstream visited cells from the considered cell. The flux values are then filtered, which may correspond to discarding the lowest flux values or setting the lowest flux values to, e.g., zero. The remaining flux values (i.e., the most significant ones) give the skeleton which represents the topology of the geological and/or geophysical property values of the reservoir grid.

In order to reduce the memory constraints, the proposed solution splits the reservoir grid into N_{B}≥3 blocks. Also, when performing a front-propagation, if a front propagation path from one block, referred to as upstream block, propagates towards another block, referred as downstream block, then the front propagation paths are used to determine downstream seed cells in the downstream block (on the interface with the upstream block). Thanks to these downstream seed cells, the front-propagation in each downstream block can be performed independently from the upstream block, which needs not to be maintained in memory for the purpose of the front-propagation in each downstream block. Hence, the front-propagation can also be split, and performed on a block by block basis, by performing the front-propagation from the downstream seed cells of each downstream block.

For the back-propagation, the memory constraints are also reduced by performing the back-propagation over fewer consecutive blocks. While the solution in WO 2020/254851 A1 performs the back-propagation over the whole length of the front propagation paths, from the extremities (last visited cells) of the front propagation paths back to the initial seed cell(s), the computation of the flux values for a given block considers here only a limited number of downstream blocks, within a predetermined block distance 1≤D_{B}≤N_{B}−2 from the considered given block. The block distance between a first block and a second block corresponds to the minimum number of intermediate blocks travelled by front propagation paths which propagate from the first block to the second block, plus one. Hence, a block distance equal to one means that the shortest front propagation path propagates from the first block to the second block without traveling through any intermediate block. A block distance equal to two means that the shortest front propagation path propagates from the first block to the second block through a single intermediate block, i.e., from the first block to the intermediate block and from the intermediate block to the second block, etc.

Computing the flux values by considering only downstream blocks within a predetermined block distance 1≤D_{B}≤N_{B}−2 from each considered block reduces the memory constraints. Indeed, while in the prior art solution the memory constraints are mainly driven by the size of the whole reservoir grid, i.e., by the size of all N_{B} blocks, in the proposed solution the memory constraints are mainly driven by the size of D_{B} blocks. While the front-propagation can be performed independently for each block without impacting the relevance of the skeleton, reducing the number of blocks for computing the flux values may impact the skeleton computed, which may slightly differ from the skeleton that would be computed by considering simultaneously the whole reservoir grid. Hence, the predetermined block distance D_{B} ensures that the flux values are computed by considering at least two blocks, thereby limiting the impact on the skeleton computation. Also, the block distance D_{B} can be tailored to the amount of memory available for performing the computation of the skeleton and may be increased if desired, if compatible with the amount of memory available, to reduce the impact on the skeleton computation. However, the inventors have noticed that, even with a block distance D_{B}=1, the impact on the skeleton (compared to considering the whole reservoir grid) was quite low, especially when the number of cells in each block remains important (e.g., 10⁶ or 10⁷ cells).

In specific embodiments, the analyzing method can further comprise one or more of the following optional features, considered either alone or in any technically possible combination.

In specific embodiments, D_{B}=2 or D_{B}=1.

In specific embodiments, D_{B}=1 and, for a middle block which corresponds to a block which, when front-propagating, comprises an upstream block and a downstream block both adjacent to said middle block, the processing of the middle block comprises:
performing a front-propagation phase in the middle block by front-propagating from at least one downstream seed cell determined based on the front propagation paths in the upstream block,
performing a first back-propagation phase in the middle block before a front-propagation phase and a first back-propagation phase are both performed in the downstream block,
performing a second back-propagation phase in the middle block after the front-propagation phase and the first back-propagation phase have been performed in the downstream block,
performing a filtering phase in the middle block to obtain the block-skeleton for the middle block.

Such provisions are advantageous in that they enable making extensive use of parallel processing to accelerate the computation of the skeleton. For instance, when the first back-propagation phase is performed in the middle block, the front-propagation phase can be performed in parallel in the downstream block, when the first back-propagation phase is completed in the middle block, the second back-propagation in the upstream block can be performed in parallel with, e.g., the front-propagation phase in the downstream block and/or the first back-propagation phase in the downstream block, etc.

In specific embodiments, D_{B}=1 and, for a branch block which corresponds to a block which, when front-propagating, comprises two downstream blocks adjacent to said branch block, the processing of the branch block comprises:
performing a front-propagation phase in the branch block,
performing a first back-propagation phase in the branch block before a front-propagation phase and a first back-propagation phase are both performed in any of the two downstream blocks,
performing a second back-propagation phase in the branch block after the front-propagation phase and the first back-propagation phase have been performed in one of the two downstream blocks,
performing a third back-propagation phase in the branch block after the front-propagation phase and the first back-propagation phase have been performed in the other one of the two downstream blocks.

In specific embodiments, the reservoir grid is split into blocks arranged along a single dimension between a first block and a last block, such that each block which is neither the first block nor the last block has exactly two adjacent blocks.

In specific embodiments:
the reservoir grid is split into blocks arranged along a single dimension between a first block and a last block, such that each block which is neither the first block nor the last block has exactly two adjacent blocks, and
the back-propagation for obtaining the flux values for a considered block having a single adjacent downstream block is performed by back-propagating in a single phase from a furthest downstream block of the considered block, within the block distance D_{B}, up to said considered block.

In specific embodiments, analyzing the reservoir geological formation based on the skeleton determined based on the reservoir grid comprises at least one among the following:
determining connectivities inside the reservoir geological formation (e.g., determining what is the path linking, e.g., a well to a non-drill sand body, etc.),
determining a strength of connection between two areas of the reservoir geological formation, e.g., based on a number of branches of the skeleton between the two groups of cells representing said areas of the reservoir geological formation,
correcting a simulation model of the reservoir geological formation (see, e.g., EP 3929630 and EP 3929631), thereby improving the analysis of the reservoir geological model,
predicting an amount of hydrocarbon that may be recovered from the reservoir geological formation by restricting, in a simulation model, the reservoir grid to the cells of the skeleton,
predicting an amount of carbon dioxide that may be stored in the reservoir geological formation by restricting, in a simulation model, the reservoir grid to the cells of the skeleton, etc.

According to a second aspect, the present disclosure relates to a computer program product comprising instructions which, when executed by at least one processor, configure said at least one processor to carry out an analyzing method according to any one of the embodiments of the present disclosure.

According to a third aspect, the present disclosure relates to a computer-readable storage medium comprising instructions which, when executed by at least one processor, configure said at least one processor to carry out an analyzing method according to any one of the embodiments of the present disclosure.

According to a fourth aspect, the present disclosure relates to a computer system for analyzing a reservoir geological formation by using a reservoir grid, said computer system comprising at least one processor and at least one memory, said at least one processor being configured to carry out an analyzing method according to any one of the embodiments of the present disclosure.

### BRIEF DESCRIPTION OF THE SEVERAL VIEWS OF THE DRAWINGS

The present disclosure will be better understood upon reading the following description, given as an example that is in no way limiting, and made in reference to the figures which show:

FIG. 1 is a flow chart illustrating the main steps of a method for analyzing a reservoir geological formation;

FIG. 2 is a schematic representation of an example of a reservoir grid split into a plurality of blocks,

FIG. 3 is a flow chart illustrating examples of data flows between different grids of different blocks.

In these figures, references identical from one figure to another designate identical or analogous elements. For reasons of clarity, the elements shown are not to scale, unless explicitly stated otherwise.

Also, the order of steps represented in these figures is provided only for illustration purposes and is not meant to limit the present disclosure which may be applied with the same steps executed in a different order.

### DETAILED DESCRIPTION

As discussed above, the present disclosure relates inter alia to a method 10 for analyzing a reservoir geological formation by using a reservoir grid. For instance, the analyzing method 10 may be used for hydrocarbon (oil, natural gas, shale gas, etc.) recovery from the reservoir geological formation and/or for carbon dioxide storage in said reservoir geological formation.

The analyzing method 10 is carried out by a computer system (not represented in the figures). In preferred embodiments, the computer system comprises one or more processors and one or more memories. The one or more processors may include for instance a central processing unit (CPU), a graphical processing unit (GPU), a digital signal processor (DSP), a field-programmable gate array (FPGA), an application specific integrated circuit (ASIC), etc. The one or more memories may include any type of computer readable volatile and non-volatile memories (magnetic hard disk, solid-state disk, optical disk, electronic memory, etc.). The one or more memories may store a computer program product, in the form of a set of program-code instructions to be executed by the one or more processors in order to implement all or part of the steps of the analyzing method 10.

The analyzing method 10 analyzes the reservoir geological formation based on a reservoir grid which models the reservoir geological formation. As indicated above, the reservoir grid represents the 3D volume of the underground reservoir geological formation as a 3D grid of cells, each cell corresponding to a volume of the 3D grid which may be substantially cubic or have a more complex shape. Each cell of the reservoir grid is mapped to a corresponding portion of the reservoir geological formation. Each cell of the reservoir grid is associated to values of geological properties of the corresponding portion of the reservoir geological formation. The geological properties may be, e.g., the facies (geological index), the porosity, the permeability, etc.

The reservoir grid may for instance be used in a simulation model which may be used to simulate hydrocarbon extraction from the reservoir geological formation and/or carbon dioxide storage in the reservoir geological formation.

However, in other examples, the reservoir grid may also be any 3D or 4D seismic image representing the reservoir geological formation. In such a case, the cells correspond to voxels representing respective portions of the reservoir geological formation, and each cell is associated to values of geophysical properties of the corresponding portion of the reservoir geological formation. The geophysical properties may be, e.g., the seismic wave velocity change (4D), the acoustic impedance, the rock density, etc. Among other applications, the analysis of a reservoir grid which corresponds to such a 3D or 4D seismic image may be used to establish/update/correct a simulation model of the reservoir geological formation.

In order to analyze the reservoir geological formation, the analyzing method 10 computes a skeleton of the reservoir grid.

In shape analysis, the skeleton (or topological skeleton) of a shape is a thin version of that shape which usually emphasizes topological properties of the shape. There are different known algorithms for calculating such a skeleton (a.k.a. skeletonization algorithms). Applied to a reservoir grid, the skeleton computed represents an estimated topology of the geological/geophysical property values of the cells of the reservoir grid, and therefore emphasizes the main paths of the geological/geophysical property inside the reservoir geological formation.

A preferred non-limitative example for the calculation of the skeleton is given by the PCT patent application WO 2020/254851 A1, the contents of which are hereby incorporated by reference.

In this example (and in many skeletonization algorithms), the skeleton is determined by front-propagating from at least one initial seed cell to determine front propagation paths in the reservoir grid. The at least one initial seed cell is provided as an input to the skeletonization algorithm, and to the front-propagation. The at least one initial seed cell is for instance provided by a user. For example, the user may select the one or more initial seed cells by graphical interaction with the reservoir grid, e.g., by clicking on each cell the user wishes to select as initial seed cell, the reservoir grid being displayed on a display. Alternatively, the user may select the one or more initial seed cells by explicitly providing, e.g., their coordinates in the reservoir grid. For instance, an initial seed cell may correspond to a well completion.

The front-propagation from the at least one initial seed cell may use, e.g., a fast marching algorithm, a best neighbor propagation algorithm, etc. For instance, the front-propagation comprises iteratively expanding a front of cells from an initial seed cell.

The front-propagation results in visited cells. By “visited cell”, it is meant any cell of the reservoir grid which has been part of the front of cells at an iteration of the front-propagation. The visited cells may be all the cells of the reservoir grid or at least a part of the cells of the reservoir grid, e.g., depending on whether the front-propagation has a stopping criterion or not and/or depending on the geological/geophysical property values.

The front-propagation stores a parent cell for each visited cell, the parent cell of a visited cell corresponding the cell from which the expansion of the front of cells has resulted in visiting the considered visited cell. Hence, using this property (parent cell) it is easy to retrieve the paths, referred herein as front propagation paths, from the initial seed cell to any last visited cell reached by front-propagating from this initial seed cell, and vice versa. A last visited cell is a visited cell which is not the parent cell of another cell.

The skeleton is further determined by determining flux values for cells of the reservoir grid by back-propagating along the front propagation paths.

The back-propagation designates any method for back-propagating one or more visited cells, up to the initial seed cell, along the front propagation paths. In other words, back-propagating a cell means going backwards along the front propagation paths to which said cell belongs up to the initial seed cell from which said cell has been reached by the front-propagation.

The back-propagation comprises computing a flux value for each back-propagated cell. For instance, the flux value for a cell corresponds to a number of visited cells which are back-propagated up to the considered cell. In examples, the flux value of a cell is equal to the number of cells visited from the considered cell, or in other words, the number of visited cells which have for ancestor the considered cell. An ancestor cell of a visited cell corresponds to a cell which is upstream said visited cell according to the front propagation paths. By definition, the initial seed cell is an ancestor cell for all the cells which have been visited by front-propagating from said initial seed cell.

In examples, the back-propagation may comprise setting to an initial value the flux value on each visited cell. In these examples, the back-propagation may further comprise, for each considered visited cell, iteratively finding each ancestor cell of the considered visited cell and, each time an ancestor cell is found, incrementing the flux value on the ancestor cell. This can be performed for all or part of the last visited cells and for each visited cell on the front propagation paths leading to the considered last visited cells.

Finally, the skeleton may be obtained by filtering the flux values obtained by back-propagating along the front propagation paths. For instance, the filtering may comprise comparing the flux values to a predetermined threshold. For instance, the filtering comprises keeping only the cells of the reservoir grid which have flux values greater or equal than the predetermined threshold. Increasing the predetermined threshold will typically make the computed skeleton thinner, emphasizing the main front propagation paths of the reservoir grid. Of course, the predetermined threshold may be adjusted to obtain a skeleton more or less thin. For instance, the flux values of the cells having flux values lower than the predetermined threshold may be set to zero. Filtering the flux values, thereby producing the skeleton, enables to identify the cells which, from the initial seed cell, correspond to intensively front-propagated geological/geophysical property values. For instance, if the geological property is a porosity, this allows to obtain a distribution of flux values representative of (e.g., connected) regions of the reservoir geological formation with high porosity, such as channels. In other examples, if the geological property is a permeability, this allows to obtain a distribution of flux values representative of (e.g., connected) regions of the reservoir geological formation with high propagation of fluid flows, such as connections between injection wells and production wells.

Accordingly, the skeleton computed based on a reservoir grid corresponds to a set of connected cells (the cells being connected by the front propagation paths, i.e., each visited cell of the skeleton has a parent cell) which represents the main paths of the geological/geophysical property inside the reservoir geological formation.

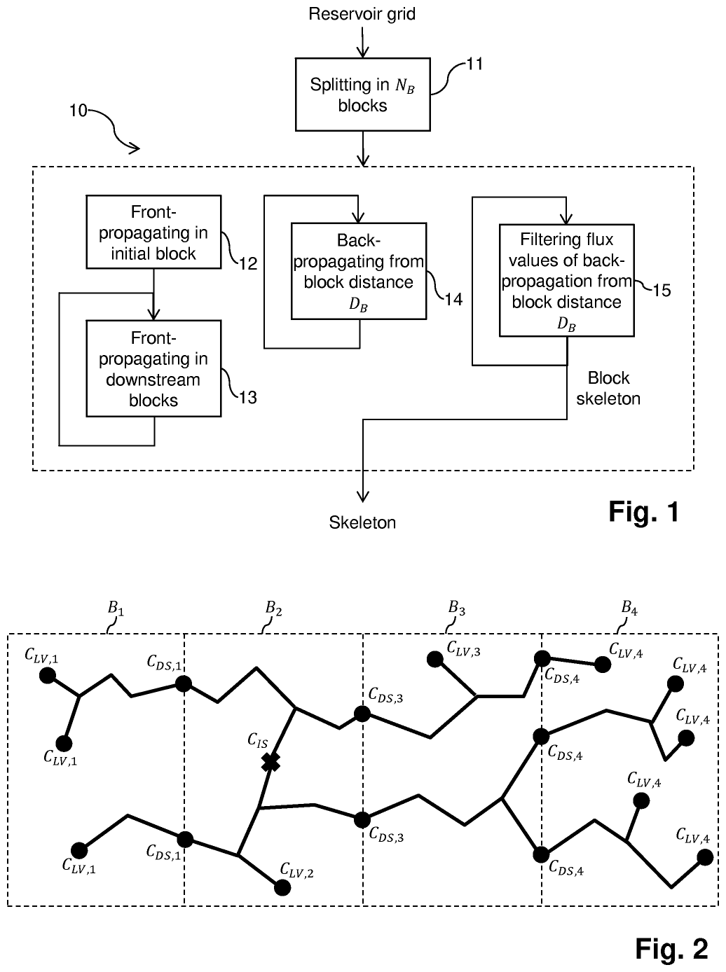

FIG. 1 represents schematically the main steps of an exemplary embodiment of a method 10 for analyzing a reservoir geological formation.

As illustrated by FIG. 1, the analyzing method 10 comprises a step 11 of splitting the reservoir grid into N_{B} blocks Bₙ, with N_{B}≥3 and 1≤n≤N_{B}. For instance, it may occur that the reservoir grid may not be processed globally due to memory constraints (e.g., insufficient RAM/memory stack) and splitting the reservoir grid into a plurality of blocks Bₙ may enable to reduce the memory required for the processing, provided that the blocks Bₙ are not all simultaneously processed, as will be discussed hereinbelow.

One of the N_{B} blocks is selected as initial block. The initial block comprises at least one initial seed cell. If there is only one initial seed cell, then the initial block corresponds to the block comprising this single initial seed cell. If there are more than one initial seed cell, then the initial block is for instance the block which comprises the greater number of initial seed cells.

As illustrated by FIG. 1, the analyzing method 10 comprises a step 12 of front-propagating from the at least one initial seed cell in the initial block to identify blocks adjacent to the initial block and which are downstream to said initial block according to the front propagation paths, and of determining at least one downstream seed cell in each downstream block that is adjacent to said initial block. Basically, a downstream seed cell in a downstream block adjacent to the initial block corresponds to the first visited cell in said downstream block along a front propagation path originating from the initial seed cell. In other words, a downstream seed cell corresponds to the intersection of a front propagation path with a frontier of the downstream block with the initial block, wherein said frontier corresponds to all the cells of the downstream block which are adjacent to cells of the initial block. A plurality of such downstream seed cells may be identified in each downstream block, which correspond to all the intersections of the frontier with front propagation paths originating from the initial seed in the initial block.

As illustrated by FIG. 1, the analyzing method 10 comprises an iterated step 13 of front-propagating in each downstream block which comprises at least one downstream seed cell determined based on the front-propagating paths of an upstream block. Hence, the front propagation paths are pursued in each downstream block adjacent to the initial block, from each downstream seed cell of this downstream block. The pursued front propagation paths might travel towards another downstream block, adjacent to the current downstream block which is therefore also upstream to said other downstream block, thereby producing one or more downstream seed cells in said another downstream block. Each block reached by propagating the front propagation paths from a downstream seed cell of a downstream block may be processed similarly, thereby successively identifying downstream seed cells in downstream blocks reached successively by the front propagation paths.

Hence, after front-propagating front the initial block successively in all downstream blocks, each downstream block that has been reached by front propagation paths includes portions of front propagation paths and one or more downstream seed cells. The initial block also has portions of front propagation paths and the at least one initial seed cell.

FIG. 2 represents schematically the front-propagation in successive blocks. In FIG. 2, N_{B}=4 and the blocks Bₙ are arranged along a single dimension between a first block B₁ and a last block B₄, such that each block which is neither the first block B₁ nor the last block B₄ has exactly two adjacent blocks. In the non-limitative example illustrated by FIG. 2, the initial block corresponds to the block B₂ which includes a single initial seed cell C_{IS}. It should be noted that only few front propagation paths are represented in FIG. 2, for clarity purposes. In practice, front-propagating from the initial seed cell C_{IS} would provide significantly more front propagation paths since the front-propagation expands a front of cells. Basically, the front propagation paths illustrated in FIG. 2 can be seen as the main front propagation paths that will remain in the skeleton after the back-propagation and the filtering are performed (which main front propagation paths are not known when performing the front-propagation), to avoid representing all front propagation paths for clarity purposes.

When front-propagating from the initial seed cell C_{IS}, the front propagation paths reach both adjacent blocks B₁ and B₃, which are therefore downstream blocks for the initial block B₂. One of the front propagation paths in the initial block ends at a last visited cell C_{LV,2}.

The front propagation paths in the initial block B₂ enter (intersect) the block B₁ at downstream seed cells C_{DS,1}. These front propagation paths enter (intersect) the block B₃ at downstream seed cells C_{DS,3}.

In the block B₁, the front propagation paths are pursued from the downstream seed cells C_{DS,1} and end at respective last visited cells C_{LV,1}.

In the block B₃, the front propagation paths are pursued from the downstream seed cells C_{DS,3}. One of the front propagation paths ends at a last visited cell C_{LV,3}. The other front propagation paths reach the block B₄. Hence, according to the front propagation paths, the block B₄ is a downstream block for the block B₃, and the block B₃ is an upstream block for the block B₄. The front propagation paths in the block B₃ enter (intersect) the block B₄ at downstream seed cells C_{DS,4}.

In the block B₄, the front propagation paths are pursued from the downstream seed cells C_{DS,4} and end at respective last visited cells C_{LV,4}.

So far, we have discussed the front-propagation. As illustrated by FIG. 1, the analyzing method 10 comprises processing each block which comprises an initial seed cell or a downstream seed cell by performing:
a step 14 of back-propagating along the front propagation paths, up to the processed block, only from downstream blocks which are within a predetermined block distance D_{B} from the processed block, wherein 1≤D_{B}≤N_{B}−2,
a step 15 of filtering the flux values of the processed block obtained by back-propagating only from within the block distance D_{B}, thereby producing a block-skeleton for the processed block.

Hence, a block-skeleton is computed for each block which comprises an initial seed cell or a downstream seed cell, and the skeleton for the reservoir grid is obtained by combining the block skeletons obtained for the processed blocks.

Accordingly, the back-propagation is performed over fewer consecutive blocks than in the prior art solutions. The computation of the flux values for a given block considers here only a limited number of downstream blocks, within a predetermined block distance 1≤D_{B}≤N_{B}−2 from the considered given block. Hence, the back-propagation for a given block is not necessarily performed (only) from last visited cells and can be performed from downstream seed cells of downstream blocks. In the case of blocks Bₙ arranged along a single dimension as in FIG. 2, the back-propagation for a given block is performed on at most D_{B}+2 blocks. For instance, if we consider the example of FIG. 2 with D_{B}=1, then the back-propagation up to the initial block B₂ is performed by back-propagating from blocks B₁ and B₃, for a total of 3 blocks (B₁, B₂ and B₃). For the block B₃, the back-propagation is performed from the block B₄, for a total of 2 blocks (B₃ and B₄). The block B₄ does not have any downstream block, so the back-propagation for this block is performed over a single block (i.e., B₄).

Once the back-propagation is completed for a given block (i.e., all downstream blocks within the block distance D_{B} have been back-propagated up to the considered block, the flux values can be filtered during a filtering phase (step 15), to produce the corresponding block-skeleton. For instance, the threshold may be the same for all blocks, in particular when the number of cells in each block remains important (e.g., 10⁶ or 10⁷ cells). For instance, for blocks having around 10⁶ cells, it is possible to use a threshold of around 10⁴.

It should be noted that the back-propagation for obtaining the flux values for a given block may be performed in a single back-propagation phase or it may be decomposed in a plurality of back-propagation phases. For instance, if we consider the example of FIG. 2 with N_{B}=1, the back-propagation up to the block B₃ may be done in a single back-propagation phase which back-propagates successively in the downstream block B₄ and in the block B₃.

However, the back-propagation in the block B₃ alone (i.e., without the block B₄) is also required for back-propagating up to the initial block B₂ within the block distance D_{B}. Hence, it may be advantageous to perform a first back-propagation phase in the block B₃ alone (i.e., by back-propagating from the parent cells of the downstream seed cells C_{DS,4} up to the downstream seed cells C_{DS,3}), and to perform a second back-propagation phase after a first back-propagation phase has been performed in the block B₄ alone (by back-propagating from the last visited cells C_{LV,4} up to the downstream seed cells C_{DS,4}). In some examples, the second back-propagation phase in the block B₃ may consist in, for each downstream seed cell C_{DS,4}, adding the flux value of the downstream seed cell C_{DS,4} to all its ancestor cells in the block B₃. Hence, the flux value of a downstream seed cell C_{DS,4} is recursively added to parent cells, from its parent cell in the block B₃ up to its ancestor downstream seed cell C_{DS,3} (or up to its ancestor initial seed cell in the case of a block comprising one).

Such a decomposition in two or more back-propagation phases may be useful for any block as the block B₃, referred to as middle block, which comprises an upstream block (which may use the result of the first back-propagation phase) and a downstream block (which provides the result of its first back-propagation phase which is used in the second back-propagation phase of the middle block). It is possible to have more than two back-propagation phases, for instance if the block distance D_{B} is greater than 1 (D_{B}>1).

In some embodiments, when D_{B}=1, the processing of a middle block having a single downstream block is performed preferably according to the following ordered sequence:
performing a front-propagation phase in the middle block by front-propagating from each downstream seed cell of the middle block,
performing a first back-propagation phase in the middle block before a first back-propagation phase is performed in the downstream block (wherein the first back-propagation phase in the downstream block requires that a front-propagation phase is performed beforehand in said downstream block),
performing a second back-propagation phase in the middle block after the first back-propagation phase has been performed in the downstream block,
performing a filtering phase in the middle block to obtain the block-skeleton for the middle block.

It should be noted that such a decomposition in two or more back-propagation phases may be useful for a block having at least two adjacent downstream blocks, such a block being referred to as branch block. The initial block B₂ in FIG. 2 is an example of such a branch block since it comprises two downstream blocks B₁ and B₃.

In some embodiments, when D_{B}=1, the processing of a branch block, having two downstream blocks adjacent to said branch block, is performed preferably according to the following ordered sequence:
performing a front-propagation phase in the branch block,
performing a first back-propagation phase in the branch block before a front-propagation phase and a first back-propagation phase are both performed in any of the two downstream blocks,
performing a second back-propagation phase in the branch block after the front-propagation phase and the first back-propagation phase have been performed in one of the two downstream blocks,
performing a third back-propagation phase in the branch block after the front-propagation phase and the first back-propagation phase have been performed in the other one of the two downstream blocks.

We now describe a non-limitative example of an ordered sequence of steps which can be executed to compute the skeleton for the example illustrated in FIG. 2 of a reservoir grid decomposed in N_{B}=4 blocks Bₙ which are arranged along a single dimension between a first block B₁ and a last block B₄, wherein the initial block corresponds to the block B₂ (which has two downstream blocks, respectively B₁ and B₃) and D_{B}=1.

In this non-limitative example, different grids are computed for each block Bₙ during the computation of the skeleton:
a front-propagation grid Gₙ which provides the father cell for each visited cell in the block Bₙ,
a flux grid Fₙ which provides the flux values for each visited cell in the block Bₙ.

Table 1 below provides a non-limitative example of an ordered sequence of steps which can be executed. For each step, the grids (among Bₙ, Gₙ and Fₙ) which are used (i.e., stored in non-volatile memory) are indicated for each block. In Table 1, the superscript W (for “write”) indicates that the grid is either created or modified during the step, while the superscript R (for “read”) indicates that the grid is read during the step. In Table 1, it is assumed that the block skeleton for the block Bₙ is stored directly in the flux grid Fₙ.

TABLE 1

| Step | Actions | B₁ | B₂ | B₃ | B₄ |
|---|---|---|---|---|---|
| S1 | Front-propagation in B₂ | | ${B}_{2}^{R} , {G}_{2}^{W}$ | | |
| S2 | Back-propagation in B₂ | | ${G}_{2}^{R} , {F}_{2}^{W}$ | | |
| S3 | Front-propagation in B₃ | | ${G}_{2}^{R}$ | ${B}_{3}^{R} , {G}_{3}^{W}$ | |
| S4 | Back-propagation in B₃ | | | ${G}_{3}^{R} , {F}_{3}^{W}$ | |
| S5 | Back-propagation in B₂ | | ${F}_{2}^{W}$ | ${F}_{3}^{R}$ | |
| S6 | Front-propagation in B₄ | | | ${G}_{3}^{R}$ | ${B}_{4}^{R} , {G}_{4}^{W}$ |
| S7 | Back-propagation in B₄ | | | | ${G}_{4}^{R} , {F}_{4}^{W}$ |
| S8 | Back-propagation in B₃ | | | ${F}_{3}^{W}$ | ${F}_{4}^{R}$ |
| S9 | Filtering in B₄ (block skeleton) | | | | ${F}_{4}^{W}$ |
| S10 | Filtering in B₃ (block skeleton) | | | ${F}_{3}^{W}$ | |
| S11 | Front-propagation in B₁ | ${B}_{1}^{R} , {G}_{1}^{W}$ | ${G}_{2}^{R}$ | | |
| S12 | Back-propagation in B₁ | ${G}_{1}^{R} , {F}_{1}^{W}$ | | | |
| S13 | Back-propagation in B₂ | ${F}_{1}^{R}$ | ${F}_{2}^{W}$ | | |
| S14 | Filtering in B₁ (block skeleton) | ${F}_{1}^{W}$ | | | |
| S15 | Filtering in B₂ (block skeleton) | | ${F}_{2}^{W}$ | | |

In step S3, the grid

$${G}_{2}^{R}$$

is used to identify the downstream seed cells in the block B₃. The same holds also for steps S6 and S11. Also, in Table 1, while the order of some steps is constrained (for instance the front-propagation phase in a block needs to be performed before the first back-propagation phase in that block, which needs to be performed before the second back-propagation phase in that block, etc.), the order for some other steps is not constrained. For instance, it is possible to front-propagate in the block B₁ (step S11) before front-propagating in the block B₃, etc. Some steps can also be executed in parallel provided there is enough memory for storing the corresponding grids. For instance, the steps S11 to S15 can be executed in parallel with the steps S6 to S10.

As can be seen in Table 1, not all grids need to be stored in non-volatile memory and/or processed simultaneously. In contrast, in prior art solutions, it would be necessary to use simultaneously the whole reservoir grid (i.e., all N_{B} blocks Bₙ), a whole front-propagation grid G (i.e., all NB front-propagation grids Gₙ) and a whole flux grid F (i.e., all N_{B} flux grids Fₙ).

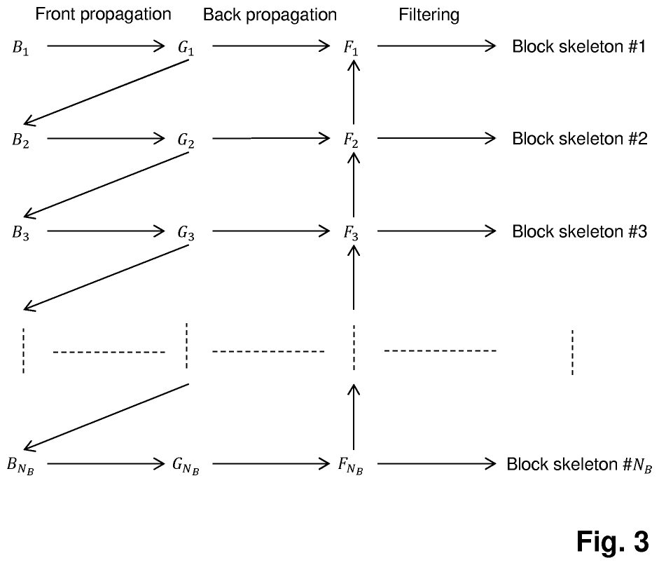

FIG. 3 represents schematically examples of dataflows and relation dependencies between the different grids discussed above, in the case of data blocks By which are arranged along a single dimension between a first block B₁ and a last block B_{N}_{_{B}}, wherein the initial block corresponds to the block B₁. FIG. 3 considers the case where the back-propagation for a given block is decomposed in a plurality of back-propagation phases. In FIG. 3, the final flux grid Fₙ (i.e., the flux grid which is filtered to obtain the block skeleton #n) depends:
directly on the front-propagation grid Gₙ,
directly on the flux grid Fₙ₊₁ if n<N_{B},
indirectly on the flux grid(s) Fₙ₊₂ to F_{min(n+D}_{_{B}}_{,N}_{_{B}}₎ if D_{B}>1 and (n+1)<N_{B}.

It is emphasized that the present disclosure is not limited to the above exemplary embodiments. Variants of the above exemplary embodiments are also within the scope of the present disclosure.

For instance, the present disclosure has mainly assumed the case of blocks arranged along a single dimension between a first block and a last block. However, it is possible to have blocks arranged along two dimensions, in which some blocks may have more than two adjacent blocks. In such a case, each middle block may have, e.g., more than one adjacent downstream block, which may require, e.g., performing additional back-propagation phases. It is also possible, in other examples, to have blocks arranged along three dimensions.

Also, the present disclosure has mainly assumed the case where D_{B}=1. However, it is also possible, in other examples, to consider greater values for the block distance D_{B}, for instance D_{B}=2 or even more, provided 1≤D_{B}≤N_{B}−2. Of course, reducing the block distance D_{B} reduces the memory constraints. The inventors have also noticed that the skeletons obtained with a block distance D_{B}=1 are similar to those obtained in prior art solutions (i.e., considering the whole reservoir grid for the back-propagation) if the number of cells of each block remains important compared to the number of cells of the reservoir grid, which is the case for instance for N_{B}≤10.

The above description clearly illustrates that by its various features and their respective advantages, the present disclosure reaches the goals set for it, since it enables to reduce the memory constraints for computing skeletons for large reservoir grids while still obtaining accurate skeletons.

Such skeletons are very useful for analyzing reservoir geological formations. For instance, the skeleton determined based on the reservoir grid may be used for, e.g.:
determining connectivities inside the reservoir geological formation (e.g., determining what is the path linking, e.g., a well to a non-drill sand body, etc.),
determining a strength of connection between two areas of the reservoir geological formation, e.g., based on a number of branches of the skeleton between the two groups of cells representing said areas of the reservoir geological formation,
correcting a simulation model of the reservoir geological formation (see, e.g., EP 3929630 and EP 3929631),
predicting an amount of hydrocarbon that may be recovered from the reservoir geological formation by restricting, in a simulation model, the reservoir grid to the cells of the skeleton,
predicting an amount of carbon dioxide that may be stored in the reservoir geological formation by restricting, in a simulation model, the reservoir grid to the cells of the skeleton, etc.

The various embodiments described above can be combined to provide further embodiments. All of the patents, applications, and publications referred to in this specification and/or listed in the Application Data Sheet are incorporated herein by reference, in their entirety. Aspects of the embodiments can be modified, if necessary to employ concepts of the various patents, applications, and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled.

1. A computer implemented method for analyzing a reservoir geological formation by using a reservoir grid, said reservoir grid corresponding to a 3D grid of cells wherein each cell represents a respective portion of the reservoir geological formation, wherein said method comprises:
determining a skeleton of the reservoir grid and analyzing the reservoir geological formation based on the skeleton,
wherein the skeleton is determined by front-propagating from at least one initial seed cell to determine front propagation paths in the reservoir grid, by determining flux values for cells of the reservoir grid by back-propagating along the front propagation paths, and by filtering the flux values,
wherein the method further comprises splitting the reservoir grid into N_{B} blocks, with N_{B}≥3, and:
front-propagating from an initial block comprising the at least one initial seed cell to identify blocks adjacent to the initial block and which are downstream to said initial block according to the front propagation paths, and determining at least one downstream seed cell in each downstream block that is adjacent to said initial block,
iteratively front-propagating in each downstream block which comprises at least one downstream seed cell determined based on the front-propagating paths of an upstream block, and
processing each block which comprises an initial seed cell or a downstream seed cell by:
back-propagating along the front propagation paths, up to the processed block, only from downstream blocks which are within a predetermined block distance D_{B} from the processed block, wherein 1≤D_{B}≤N_{B}−2, and
filtering the flux values of the processed block obtained by back-propagating only from within the block distance D_{B}, thereby producing a block-skeleton for the processed block,
wherein the skeleton for the reservoir grid is obtained by combining the block skeletons obtained for the processed blocks.

2. The method according to claim 1, wherein D_{B}=2 or D_{B}=1.

3. The method according to claim 1, wherein D_{B}=1 and, for a middle block which corresponds to a block which, when front-propagating, comprises an upstream block and a downstream block both adjacent to said middle block, the processing of the middle block comprises:
performing a front-propagation phase in the middle block by front-propagating from at least one downstream seed cell determined based on the front propagation paths in the upstream block,
performing a first back-propagation phase in the middle block before a front-propagation phase and a first back-propagation phase are both performed in the downstream block,
performing a second back-propagation phase in the middle block after the front-propagation phase and the first back-propagation phase have been performed in the downstream block, and
performing a filtering phase in the middle block to obtain the block-skeleton for the middle block.

4. The method according to claim 1, wherein D_{B}=1 and, for a branch block which corresponds to a block which, when front-propagating, comprises two downstream blocks adjacent to said branch block, the processing of the branch block comprises:
performing a front-propagation phase in the branch block,
performing a first back-propagation phase in the branch block before a front-propagation phase and a first back-propagation phase are both performed in any of the two downstream blocks,
performing a second back-propagation phase in the branch block after the front-propagation phase and the first back-propagation phase have been performed in one of the two downstream blocks, and
performing a third back-propagation phase in the branch block after the front-propagation phase and the first back-propagation phase have been performed in the other one of the two downstream blocks.

5. The method according to claim 1, wherein the reservoir grid is split into blocks arranged along a single dimension between a first block and a last block, such that each block which is neither the first block nor the last block has exactly two adjacent blocks.

6. The method according to claim 1, wherein:
the reservoir grid is split into blocks arranged along a single dimension between a first block and a last block, such that each block which is neither the first block nor the last block has exactly two adjacent blocks, and
the back-propagation for obtaining the flux values for a considered block having a single adjacent downstream block is performed by back-propagating in a single phase from a furthest downstream block of the considered block, within the block distance D_{B}, up to said considered block.

7. The method according to claim 1, wherein analyzing the reservoir geological formation based on the skeleton determined based on the reservoir grid comprises at least one among the following:
determining connectivities inside the reservoir geological formation,
determining a strength of connection between two areas of the reservoir geological formation,
correcting a simulation model of the reservoir geological formation,
predicting an amount of hydrocarbon that may be recovered from the reservoir geological formation by restricting, in a simulation model using the reservoir grid, the reservoir grid to the cells of the skeleton, and
predicting an amount of carbon dioxide that may be stored in the reservoir geological formation by restricting, in a simulation model using the reservoir grid, the reservoir grid to the cells of the skeleton.

8. A computer program product stored on a non-transitory computer-readable storage medium comprising instructions which, when executed by at least one processor, configure said at least one processor to carry out the method according to claim 1.

9. A non-transitory computer-readable storage medium comprising instructions which, when executed by at least one processor, configure said at least one processor to carry out the method according to claim 1.

10. A computer system for analyzing a reservoir geological formation by using a reservoir grid, said computer system comprising at least one processor and at least one memory, said at least one processor being configured to carry out the method according to claim 1.
